(19) United States
(12) Patent Application Publication
(10) Pub. No.: US 2026/0185914 A1
(43) Pub. Date: Jul. 2, 2026

(54) ANALYTICAL ULTRACENTRIFUGATION METHODS

(71) Applicant: Brammer Bio, LLC, Cambridge, MA (US)

(72) Inventors: Laure Kairawicz, Gainesville, FL (US); Steven Milian, North Fort Myers, FL (US)

(21) Appl. No.: 18/998,393

(22) PCT Filed: Jul. 20, 2023
(86) PCT No.: PCT/US2023/028226

§ 371 Date: Jan. 24, 2025

Related U.S. Application Data
(60) Provisional application No. 63/392,261, filed on Jul. 26, 2022.

(51) Int. Cl. G01N 15/04

(52) U.S. Cl. CPC G01N 15/042; G01N 2015/045

(57) ABSTRACT

Methods of characterizing a preparation of biomolecules are provided. In some examples, methods of characterizing a preparation of viral particles are provided, including subjecting the preparation of viral particles to analytical ultracentrifugation under sedimentation velocity conditions, measuring sedimentation of the viral particles at a plurality of time points, determining a frictional ratio function c(s,ff0) and a sedimentation coefficient for the preparation of viral particles, plotting the c(s,ff0) versus the sedimentation coefficient(S) to obtain a c(s,ff0) distribution, and characterizing the presence and/or relative composition of viral particles comprising full viral genomes, partial viral genomes, overpackaged viral genomes, and/or empty viral particles in the preparation of viral particles.

### RELATED APPLICATIONS

This application is a 371 U.S. application off of International Application No. PCT/US2023/028226 filed Jul. 20, 2023, which claims the benefit for U.S. Provisional Application No. 63/392,261 filed on Jul. 26, 2022.

### FIELD

This disclosure relates to methods for characterizing biomolecule preparations, particularly viral particles, using analytical ultracentrifugation.

### BACKGROUND

Analytical ultracentrifugation (AUC) is a technique that monitors sedimentation of a sample in real-time using optical detection systems. AUC provides information such as shape, size, molecular weight, and conformational changes of biomolecules, such as proteins, nucleic acids, viruses, and other macromolecules. One application of AUC is characterization of preparations of biomaterials for therapeutic use, for example, viral preparations for gene therapy or antibody preparations.

### SUMMARY

Disclosed herein are methods for analyzing preparations of biomolecules utilizing analytical ultracentrifugation. In particular examples, the methods can be used to analyze preparations of viral particles, for example to characterize presence or relative amount of viral particles including a full genome in a viral particle preparation. In some examples, the provided methods provide advantages over previous methods, such as the determination of frictional ratio (indicating the shape of the particles), estimated molecular weight, and Stokes or hydrodynamic radius of the particles (indicating their size in nanometers), along with sedimentation rates and peak areas, in the same instance of analysis of the data.

Methods of characterizing a preparation of biomolecules are provided. In examples, the preparation of biomolecules is a preparation of viral particles. In some examples, the methods include characterizing a preparation of viral particles by subjecting the preparation of viral particles to analytical ultracentrifugation under sedimentation velocity conditions, measuring sedimentation of the viral particles at a plurality of time points, determining a frictional ratio function c(s,ff0) and a sedimentation coefficient for the preparation of viral particles, plotting the c(s,ff0) versus the sedimentation coefficient(S) to obtain a c(s,ff0) distribution; and characterizing the presence and/or relative composition of viral particles comprising full viral genomes, partial viral genomes, overpackaged viral genomes, and/or empty viral particles in the preparation of viral particles.

In other examples, the methods include assessing genomic integrity of viral particles in a viral preparation by subjecting the preparation of viral particles to analytical ultracentrifugation, measuring sedimentation of the viral particles at a plurality of time points, determining a frictional ratio function c(s,ff0) and a sedimentation coefficient for the preparation of viral particles, plotting the c(s,ff0) versus the sedimentation coefficient(S) to obtain a c(s,ff0) distribution, and characterizing the presence and/or relative composition of viral particles comprising full viral genomes, partial viral genomes, and/or empty viral particles in the preparation of viral particles, thereby assessing the genomic integrity of the viral particles in the viral preparation. In some examples, the c(s,ff0) is calculated using the Lamm equation, for example, using SEDFIT software package.

In some examples, the methods include measuring the sedimentation of the viral particles by measuring absorbance (such as measuring absorbance at about 280 nm). In certain examples, the methods include measuring absorbance at a plurality of time points, for example at about 75 time points. The interval between each of the plurality of time points is about 20 seconds in some examples. In one example, the analytical ultracentrifugation is performed at about 15,000 rpm and at a temperature of about 20° C.

The disclosed methods include characterizing the presence of viral particles including full viral genomes, partial viral genomes, overpackaged viral genomes, and/or empty viral particles in the preparation of viral particles and/or assessing genomic integrity of viral particles in the preparation. The methods include identifying peaks in the c(s,ff0) distribution corresponding to a sedimentation coefficient corresponding to viral particles including full viral genomes, partial viral genomes, overpackaged viral genomes, and/or empty viral particles. In some examples, the methods also include integrating the area under each peak identified in the c(s,ff0) distribution. Relative composition of each of viral particles comprising full viral genomes, partial viral genomes, overpackaged viral genomes, and/or empty viral particles in the preparation of viral particles is determined by comparing the peak area values within the preparation.

In some examples, the viral particles in the preparation are capsid particles. In other examples, the preparation of viral particles is a preparation of adeno-associated virus (AAV) particles (for example, AAV2 particles, AAV3 particles, AAV6 particles, AAV8 particles, or AAV9 particles).

In one example, the method is a method of determining relative composition of adeno-associated virus (AAV) particles including full viral genomes, partial viral genomes, overpackaged viral genomes, and/or empty viral particles in a preparation of AAV particles. The methods include subjecting a preparation of AAV particles to analytical ultracentrifugation at 15,000 rpm, collecting absorbance data at 280 nm at 75 timepoints at 20 second intervals to measure sedimentation of the viral particles, determining a frictional ratio function c(s,ff0) and a sedimentation coefficient for the preparation of viral particles, plotting the c(s,ff0) versus the sedimentation coefficient(S) to obtain a c(s,ff0) distribution, assigning peaks in the c(s,ff0) distribution to a category of viral particles selected from viral particles comprising full viral genomes, viral particles comprising partial viral genomes, overpackaged viral genomes and empty viral particles, integrating area under each peak in the c(s,ff0) distribution; and comparing the area under each peak of AAV particles including full viral genomes, partial viral genomes, overpackaged viral genomes, and/or empty viral particles in the preparation of AAV particles to determine relative composition.

The foregoing and other features of the disclosure will become more apparent from the following detailed description, which proceeds with reference to the accompanying figures.

### BRIEF DESCRIPTION OF THE DRAWINGS

FIG. 1 is a diagram illustrating exemplary species of viral particles (such as AAV capsids) that can be characterized using the methods provided. In some examples, the capsid or viral particle contains a complete viral genome (is “full”). In other examples, the capsid or viral particle does not include any viral DNA (is “empty”) or contains a truncated or incomplete viral genome (“partial” genome).

FIG. 2 shows data from an exemplary analysis of AAV8 viral particles packaged with a green fluorescent protein genome. The top panel shows a plot of absorbance at 280 nm versus AUC cell sector radius in centimeters. The plot shows the totality of the AUC scans collected during an experiment. Scans show the sedimentation process of species present in the sample that was loaded into the AUC cell sample sector. The negative peak represents the reference buffer meniscus in the AUC cell reference sector. The red line identifies in the SEDFIT software the sample meniscus in the AUC cell sample sector. The left green line identifies where, in the collected scans, the SEDFIT software analysis should start modeling sedimentation. The right green line defines the end of the SEDFIT modeling sedimentation. The middle panel shows the residuals of the experiment, representing the difference between the observed absorbance data contained in the scans and the predicted data values in the modeled distribution profile of the species present in the sample. The bottom panel shows the modeled distribution profile indicating which species are present in the sample where each peak corresponds to a particular AAV species (empty, partial, full etc.).

FIG. 3 shows data from an exemplary analysis of AAV viral particles used to calculate frictional ratio (f/f0), molecular weight (sw, ffow), and Stokes radius (Rs) shown. The peak shown at 87.74S corresponds to a full GFP AAV species; the peak shown at 102S corresponds to an overpackaged AAV species, corresponding to a genome size greater than a full GFP AAV species.

### DETAILED DESCRIPTION

### I. Terms

The following explanations are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing examples from discussed prior art, the example numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

Adeno-associated virus (AAV): A small, non-enveloped virus that infects humans and some other primate species. AAV is not known to cause disease and elicits a very mild immune response. Gene therapy vectors that utilize AAV can infect both dividing and quiescent cells and can persist in an extrachromosomal state without integrating into the genome of the host cell. These features make AAV an attractive viral vector for gene therapy. In some examples, the AAV is a recombinant AAV and is replication-deficient.

Isolated: An “isolated” biological component (such as a nucleic acid molecule, protein, or virus) has been substantially separated or purified away from other biological components (e.g., other chromosomal and extra-chromosomal DNA and RNA, proteins and/or organelles). Nucleic acids, proteins, and/or viruses that have been “isolated” include nucleic acids, proteins, and viruses purified by standard purification methods. The term also embraces nucleic acids, proteins, and viruses prepared by recombinant expression in a host cell, as well as chemically synthesized nucleic acids or proteins.

The term “isolated” (or purified) does not require absolute purity; rather, it is intended as a relative term. Thus, for example, an isolated or purified nucleic acid, protein, virus, or other active compound is one that is isolated in whole or in part from associated nucleic acids, proteins, and other contaminants. In certain examples, the term “substantially purified” refers to a nucleic acid, protein, virus or other active compound that has been isolated from a cell, cell culture medium, or other crude preparation and subjected to fractionation to remove various components of the initial preparation, such as proteins, cellular debris, and other components.

Recombinant: A recombinant nucleic acid molecule is one that includes a sequence that is not naturally occurring or has a sequence that is made by an artificial combination of two otherwise separated segments of sequence. This artificial combination can be accomplished by chemical synthesis or by the artificial manipulation of isolated segments of nucleic acid molecules, such as by genetic engineering techniques.

Similarly, a recombinant virus is a virus with a nucleic acid sequence that is non-naturally occurring (such as including a heterologous sequence that is not from the virus) or made by artificial combination of at least two sequences of different origin. The term “recombinant” also includes nucleic acids, proteins and viruses that have been altered solely by addition, substitution, or deletion of a portion of a natural nucleic acid molecule, protein or virus.

As used herein, “recombinant AAV” (rAAV) refers to an AAV particle in which a heterologous nucleic acid molecule has been packaged. The heterologous nucleic acid molecule of the recombinant AAV is a combination of nucleic acid sequences that do and do not occur within the AAV genome; for example, a therapeutic nucleic acid sequence flanked by the inverted terminal repeat (ITR) nucleic acid sequences of AAV. A therapeutic nucleic acid is one that slows progression, reduces severity or symptoms of a disease. The slowed progression, reduced severity or symptoms of a disease can be caused by one or more transcripts of the heterologous nucleic acid molecule, the translation of one or more transcripts of the heterologous transcript or simply from the presence of the heterologous nucleic acid.

A full recombinant AAV is one in which the AAV capsid encapsulates a heterologous nucleic acid molecule flanked by an ITR on each end. An empty recombinant AAV is one in which the capsid does not encapsulate a heterologous nucleic acid sequence. A partial recombinant AAV is one in which the AAV capsid does encapsulate a heterologous nucleic acid but the encapsulated heterologous nucleic acid is not full length; for instance, lacking all or portion of a therapeutic nucleic acid and/or an ITR.

Reference: A sample, standard, or value that is used for comparison. In some examples, a reference is a sample including the same buffer, but lacking AAV particles (e.g., when analyzing an AAV viral particle preparation). In other examples, a reference is a sample including the same buffer and a different biomolecule than the sample being analyzed (e.g., a sample including 70S ribosome may be a reference for AAV viral particle preparations).

SEDFIT algorithm: An algorithm for analysis of hydrodynamic data, such as sedimentation velocity (Schuck, Biophys. J. 78:1606-1619, 2000). Sedimentation boundaries are simulated using solutions to the Lamm equation for each sedimentation coefficient, with constant particle shape and solvent frictional ratio.

Sedimentation coefficient(s): A measurement of how fast a particle of a given size and shape sediments, for example under centrifugation. The sedimentation coefficient is the ratio of the particle's sedimentation velocity to the applied acceleration. Sedimentation coefficient is represented by Svedberg units(S), with one Svedberg unit being equivalent to 10-13 seconds.

Vector: A nucleic acid molecule (such as a plasmid or a virus) allowing insertion of foreign nucleic acid without disrupting the ability of the vector to replicate and/or integrate in a host cell. A vector can include nucleic acid sequences that permit it to replicate in a host cell, such as an origin of replication. A vector can also include one or more selectable marker genes and other genetic elements. An expression vector is a vector that contains the necessary regulatory sequences to allow transcription and translation of inserted gene or genes. In some non-limiting examples, the vector is an AAV.

### II. Overview

Analytical ultracentrifugation (AUC) is a technique that can be used to analyze properties such as molecular weight, biomolecular shape, hydrodynamic properties, and thermodynamic properties of biomolecules (such as proteins, nucleic acids, or viral particles). AUC analysis can be used to characterize the biophysical properties of many types of molecules by measuring their migration through a solvent in a centrifugal field. In some examples, AUC analysis encompasses determining sedimentation velocity. Sedimentation velocity provides information regarding hydrodynamic properties of particles, including size, shape, and concentration.

Radial sedimentation of biomolecules in ultracentrifugation is affected by factors including heterogeneity of molecules in solution, intrinsic chemical interactions, and migration through buffer. The process of radial sedimentation is mathematically described by the Lamm equation, shown here for an ideal particle sedimenting without interaction as a function of time t and distance to the rotation axis, r:

$$\frac{\partial c}{\partial t} = \frac{1}{r} ( \frac{\partial }{\partial r} ) [ {\underbrace{rD \frac{\partial c}{\partial r}}}_{Diffusion Term} - {\underbrace{S {ω}^{2} {r}^{2} c}}_{Sedimentation Term} ]$$

Where c is the particle concentration, the parameters D, S, and @ represent the diffusion constant, sedimentation coefficient, and the rotor angular velocity, respectively. The sedimentation coefficient, S, depends on the particle molecular weight, M, partial specific volume [symbol] , and size stated by the hydrodynamics radius or Stokes radius, Rs. S depends also on the solvent density ρ⁰ and viscosity, η⁰, according to the Svedberg's equation (NA is Avogadro's number):

$$S = M [ \frac{( 1 - \overline{v} ρ° )}{( {N}_{A} 6 πη° Rs )} ]$$

Additionally, D and Rs are connected by the frictional coefficient f, through the Stokes relation:

$$f = 6 πη° Rs$$

And the Einstein-Stokes relation:

$$D = RT / {N}_{A} f$$

Where R is the gas constant and T is the temperature in Kelvins.

The frictional ratio f/f₀ allows the comparison of the frictional coefficient f (and the Stokes radius) to the minimum frictional coefficient, f₀, which corresponds to the volume of a particle as a perfect sphere with a radius R₀:

$$Rs = \frac{f}{{f}_{0}} {R}_{0}$$

The Lamm equation is solved by using integral functions that model specific types of molecular interactions. Two such functions are c(s) and c(s,ff0). c(s) is only a function of sedimentation rate and size distribution profiles plots c(s) versus s (sedimentation rate). c(s) imposes a set frictional ratio value (f/f0=1.2) because c(s) assumes similar frictional ratio values for each sedimenting species in solution. c(s,ff0) is a function of s and frictional ratio (f/f0). The size distribution profile plots function versus s and frictional ratio and is represented as a 2D plot. It calculates size and shape distribution and does not impose a set value of f/f0 but uses a range of values. f/f0 describes the shape of the molecule, with a ratio from 1.2-1.3 describing a spherical shape for globular compact particles and f/f0 around 1.5 describing a slightly asymmetric shape. Elongated rod and coil shapes have f/f0>2.0. In addition, depending on the function, other attributes can be calculated, such as molecular weight and Stokes radius. These functions can be evaluated using a software package such as SEDFIT.

In some examples, sedimentation of a biomolecule is measured by monitoring absorbance. In some examples, the absorbance is measured at about 230-280 nm. In one example, absorbance is measure at about 230 nm. In other examples, absorbance is measured at about 260 nm. In further examples, absorbance is measured at 280 nm. In additional examples, absorbance is measured at about 260 nm and about 280 nm. In such examples, the distribution profiles at 260 nm and 280 nm may be overlaid, for example, to confirm or characterize DNA-containing biomolecules, which have higher absorbance at 260 nm. In some examples, sedimentation of a biomolecule is measured using an ultracentrifuge including a detection system, such as a UV detection system (such as a UV/VIS spectrophotometer).

In some examples, sedimentation of a biomolecule is measured by taking scans at a plurality of time points, such as about 30-100 scans. In some examples, the sedimentation is measured by about 30-50 scans, about 50-75 scans, or about 75-100 scans (for example about 30 scans, about 40 scans, about 50 scans, about 60 scans, about 70 scans, about 75 scans, about 80 scans, about 90 scans, or about 100 scans). In one example, the sedimentation is measured with about 75 scans. In some examples, the time between scans is about 15 seconds to about 15 minutes, such as about 15 seconds to about 45 seconds, about 20 seconds to about 1 minutes, about 30 seconds to about 2 minutes, about 1 minute to about 5 minutes, about 2.5 minutes to about 10 minutes, or about 7.5 minutes to about 15 minutes (for example, about 15 seconds, about 20 seconds, about 30 seconds, about 45 seconds, about 1 minute, about 1.5 minutes, about 2 minutes, about 2.5 minutes, about 3 minutes, about 4 minutes, about 5 minutes, about 7.5 minutes, about 10 minutes, or about 15 minutes). In one example, the time interval between the scans is about 20 seconds. In other examples, the time interval between scans is about 180 seconds. An appropriate interval between scans can be selected, for example based on the biomolecule being detected.

The sedimentation is measured over the course of about 15 minutes to about 2 hours, such as about 15 minutes to 30 minutes, about 20 minutes to about 40 minutes, about 25 minutes to about 45 minutes, about 40 minutes to about 1 hour, about 1 hour to 1.5 hours, or about 1.5 hours to 2 hours (for example, about 15 minutes, about 20 minutes, about 30 minutes, about 45 minutes, about 1 hour, about 1.5 hours, or about 2 hours). In one example, the sedimentation is measured over the course of about 25 minutes.

In some examples, the analytical ultracentrifugation is performed at about 3000 rpm to about 50,000 rpm, such as about 3000 rpm to about 7500 rpm, about 5000 rpm to about 10,000 rpm, about 10,000 rpm to about 15,000 rpm, about 15,000 rpm to about 20,000 rpm, about 20,000 rpm to about 25,000 rpm, about 25,000 rpm to about 30,000 rpm, about 30,000 rpm to about 35,000 rpm, about 35,000 rpm to about 40,000 rpm, about 40,000 rpm to about 45,000 rpm, or about 45,000 rpm to about 50,000 rpm (for example, about 3000 rpm, about 4000 rpm, about 5000 rpm, about 6000 rpm, about 7000 rpm, about 8000 rpm, about 9000 rpm, about 10,000 rpm, about 11,000 rpm, about 12,000 rpm, about 13,000 rpm, about 14,000 rpm, about 15,000 rpm, about 16,000 rpm, about 17,000 rpm, about 18,000 rpm, about 19,000 rpm, about 20,000 rpm, about 25,000 rpm, about 30,000 rpm, about 35,000 rpm, about 40,000 rpm, about 45,000 rpm or about 50,000 rpm. In one example, the analytical ultracentrifugation is performed at about 15,000 rpm. In another example, the analytical ultracentrifugation is performed at about 40,000 rpm. An appropriate centrifugation speed can be selected based on the biomolecule being detected, for example, higher speeds are used for smaller molecules, such as monoclonal antibodies, compared to viral particles.

In some examples, the analytical ultracentrifugation is performed at about 4° C. to about 30° C., such as about 4° C. to about 10° C., about 10° C. to about 15° C., about 15° C. to about 20° C., about 20° C. to about 25° C., or about 25° C. to about 30° C. (for example, about 4° C., about 6° C., about 8° C., about 10° C., about 12° C., about 15° C., about 20° C., about 22° C., about 25° C., or about 30° C. In one example, the analytical ultracentrifugation is performed at about 20° C.

Exemplary biomolecules which can be analyzed or characterized using the methods provided herein include, but are not limited to virus-like particles (such as AAV particles), viral vectors (such as LV or Adenovirus), ribozymes (including ribosomes such as 70S, 80S-human ribosome), monoclonal antibodies, large glycoprotein multimers (for example, antibodies such as IgM), aggregates, multimeric molecules (such as dimers, trimers, and so on, for example rubella or influenza virus hemagglutinin rosettes), lipid nanoparticles (LNPs), or exosomes. In some examples, the disclosed methods are used for characterization or analysis of a preparation of viral particles. In other examples, the disclosed methods are used for characterization or analysis of proteins, such as antibodies (for example, monoclonal antibodies).

### III. Methods of Characterizing a Preparation of Viral Particles

In examples, methods of characterizing a preparation of viral particles are provided. In other examples, methods of assessing genomic integrity of viral particles in a viral preparation are provided.

In some examples, methods of characterizing a preparation of viral particles include subjecting a preparation of viral particles to analytical ultracentrifugation under sedimentation velocity conditions and measuring sedimentation of the viral particles at a plurality of time points. The methods also include determining a frictional ratio function c(s,ff0) and a sedimentation coefficient for the preparation of viral particles, plotting the c(s,ff0) versus the sedimentation coefficient(S) to obtain a c(s,ff0) distribution, and characterizing the presence and/or relative composition of viral particles, such as viral particles including full viral genomes, partial viral genomes, overpackaged viral genomes, and/or empty viral particles in the preparation of viral particles.

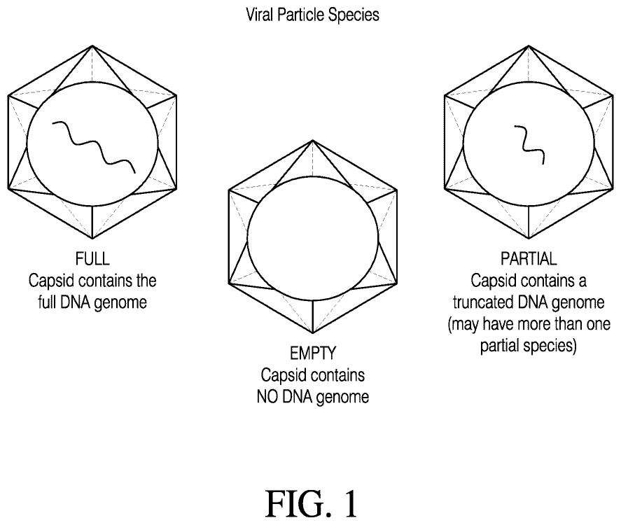

In other examples, methods of assessing genomic integrity of viral particles in a viral preparation include subjecting the preparation of viral particles to analytical ultracentrifugation and measuring sedimentation of the viral particles at a plurality of time points. The methods also include determining a frictional ratio function c(s,ff0) and a sedimentation coefficient for the preparation of viral particles, plotting the c(s,ff0) versus the sedimentation coefficient(S) to obtain a c(s,ff0) distribution, and characterizing the presence and/or relative composition of viral particles comprising full viral genomes, partial viral genomes, and/or empty viral particles in the preparation of viral particles, thereby assessing the genomic integrity of the viral particles in the viral preparation. The genomic integrity of the viral particle may include viral particles with a full viral genome (e.g., an intact or substantially intact genome, such as a complete genome), a partial viral genome (e.g., an incomplete viral genome), an overpackaged viral genome (e.g. containing genome size greater than expected), or the viral particle may be an empty viral particle (e.g., lacking or substantially lacking a viral genome). Exemplary viral particle species are illustrated in FIG. 1.

In other examples, the methods include or further include determining frictional ratio (f/f0), estimated molecular weight, and/or Stokes radius of the viral particles. The frictional ratio allows determination of biomolecular shape, with f/f0 of 1 being a perfect sphere. As the ratio increases, the shape deviates from a perfect sphere to a more oblong shape. Empty, partial genome, and full genome viral particles (such as AAVs) are substantially spherical. Aggregates have an oblong shape. Estimated molecular weight allows determination of the type of viral particle present, based on known or calculated molecular weight for an empty viral particle or viral particle with a full genome. Similar to f/f0, empty, partial genome, and full genome viral particles have similar diameters (e.g., about 20-25 nm for AAV particles); however, aggregates can be identified based on presence of larger diameter particles.

AUC of the sample is carried out as described in Section II. In some specific examples, the AUC is carried out at 15,000 rpm with collection of absorbance data at 280 nm at 75 time points at 20 second intervals to measure sedimentation of the viral particles. A frictional ratio function c(s,ff0) and a sedimentation coefficient for the preparation of viral particles are determined and the c(s,ff0) versus the sedimentation coefficient(S) is plotted to obtain a c(s,ff0) distribution. The c(s,ff0) function is calculated with the Lamm equation, for example using a software package. One software package for modeling AUC data to the Lamm equation is SEDFIT (Schuck, Biophys. J. 78:1060-1619, 2000). In some examples, parameters for buffer density and viscosity are adjusted to correspond to the sample buffer. In one example, the sample buffer is Dulbecco's phosphate buffered saline (D-PBS) and buffer density is set to 1.005584 and buffer viscosity is set to 0.0102 Poise. In some examples, (including analysis of AAV particles), partial specific volume is 0.73, reflecting a globular-shaped protein. Additional exemplary parameters for analysis of AAC particles are shown in Example 3. However, one of ordinary skill in the art can adjust these parameters for other sample types or preparations.

Characterizing the presence of viral particles with full viral genomes, partial viral genomes, overpackaged viral genomes, and/or empty viral particles in the preparation of viral particles includes identifying peaks in the c(s,ff0) distribution corresponding to a sedimentation coefficient corresponding to viral particles including full viral genomes, partial viral genomes, and/or empty viral particles. In some examples, the distribution of peaks corresponding to full viral genomes, partial viral genomes, overpackaged viral genomes and/or empty viral particles provides a qualitative analysis of the preparation.

In other examples, the methods include integrating the area under each peak in the c(s,ff0) distribution. The relative composition of each type of viral particle (those with full viral genomes, partial viral genomes, overpackaged viral genomes, and/or empty viral particles) in the preparation of viral particles is determined by comparing the peak area values. In some examples, the relative composition is determined by comparing the area under the peak of viral particles with full viral genomes to the area under the peak of viral particles with partial genomes and the area under the peak of empty viral particles to determine the relative amount of viral particles with full viral genomes in the preparation. In other examples, the relative composition is determined by comparing the area under the peak of empty viral particles is compared to the area under the peak of viral particles with full viral genomes and the area under the peak of viral particles with partial viral genomes to determine the relative amount of empty viral particles in the preparation. In further examples, the area under the peak of viral particles with partial viral genomes is compared to the area under the peak of viral particles with full viral genomes and the area under the peak of empty viral particles to determine the relative amount of viral particles with partial viral genomes in the preparation. In still further examples, the area under the peak of viral particles with overpackaged viral genomes is compared to the area under the peak of viral particles with full viral genomes and the area under the peak of empty viral particles to determine the relative amount of viral particles with overpackaged viral genomes in the preparation. This information can be utilized to evaluate process efficiency (for example, in purification schemes) or for use in a GMP setting. Thus, in some examples, the percent composition is utilized to develop or continue a purification protocol or to determine whether a particular preparation is suitable for further use (such as administering to a patient).

In some examples, the preparation of viral particles is a preparation of adeno-associated viral (AAV) particles. AAV is a small, non-enveloped helper-dependent parvovirus classified in genus Dependoparvovirus of family Parvoviridae. AAV has a linear, single-stranded DNA genome of about 4.7 kb. The genome is flanked by inverted terminal repeats (ITRs) flanking two open reading frames (ORFs), rep and cap. The rep ORF encodes four replication proteins (Rep78, Rep68, Rep52, and Rep4) and the cap ORF encodes three viral capsid proteins (VP1, VP2, and VP3) and an assembly activating protein (AAP). AAV requires a helper virus (such as adenovirus, herpes simplex virus, or other viruses) to complete its life cycle. AAV is currently in use in numerous gene therapy clinical trials worldwide. Although AAV infects humans and some other primate species, it is not known to cause disease and elicits a very mild immune response. Gene therapy vectors that utilize AAV can infect both dividing and quiescent cells and persist in an extrachromosomal state without integrating into the genome of the host cell. AAV possesses several desirable features for a gene therapy vector, including the ability to bind and enter target cells, enter the nucleus, the ability to be expressed in the nucleus for a prolonged period of time, and low toxicity.

The ITRs are the only component required for successful packaging of a heterologous protein in an AAV capsid. Thus, in some examples, the disclosed methods may be used to analyze preparations of AAV vectors that include a nucleic acid encoding a gene of interest operably linked to a promoter. In some examples, the AAV vector includes 5′ and 3′ ITRs flanking a nucleic acid encoding a gene of interest operably linked to a promoter. The vector may also include additional elements, such as an enhancer element (e.g., a nucleic acid sequence that increases the rate of transcription by increasing the activity of a promoter) and/or a polyadenylation signal. Any combination of ITRs, enhancers, promoters, polyadenylation signals, and/or other elements can be used in the AAV vectors described herein.

In one example, the methods include determining relative composition of adeno-associated virus (AAV) particles including full viral genomes, partial viral genomes, and/or empty viral particles in a preparation of AAV particles by subjecting the preparation of AAV particles to analytical ultracentrifugation at 15,000 rpm, collecting absorbance data at 280 nm at 75 timepoints at 20 second intervals to measure sedimentation of the viral particles, and determining a frictional ratio function c(s,ff0) and a sedimentation coefficient for the preparation of viral particles. Then, the c(s,ff0) versus the sedimentation coefficient(S) is plotted to obtain a c(s,ff0) distribution, peaks in the c(s,ff0) distribution are assigned to a category of viral particles selected from viral particles with full viral genomes, viral particles with partial viral genomes, and empty viral particles, and integrating area under each peak in the c(s,ff0) distribution. The relative composition is determined by comparing the area under each peak, such as comparing the area under the peak of viral particles with full viral genomes to the area under the peak of viral particles with partial genomes and the area under the peak of empty viral particles to determine the relative amount of viral particles with full viral genomes in the preparation.

In some examples, the preparation of viral particles is a preparation of adeno-associated viral (AAV) particles, such as AAV capsid particles. Exemplary AAV capsid particles include AAV1 capsids, AAV2 capsids, AAV3 capsids, AAV4 capsids, AAV5 capsids, AAV6 capsids, AAV7 capsids, AAV8 capsids, AAV9 capsids, AAV10 capsids, AAV11 capsids, AAV12 capsids, or hybrid serotypes. Hybrid serotypes are generated using transcapsidation (ITR from one serotype is cross packaged into the capsid of a different serotype), alteration of AAV capsid surface (alteration of AAV capsid tropism, by modifying viral proteins ratio or even eliminating one or two VPs), mosaic capsid serotypes (capsid subunits from different serotypes are assembled in a single virion), or adsorption of receptor ligands to AAV capsid surface to change tropism. Examples of hybrid serotypes include rh74, rh10, hu68, and AAV-DJ. In some specific examples, the AAV particles are AAV2, AAV3, AAV6, AAV8, or AAV9 particles, such as AAV2 capsid particles, AAV3 capsid particles, AAV6 capsid particles, AAV8 capsid particles, or AAV9 capsid particles.

In other examples, the preparation of viral particles is a preparation of Adenoviridae (Adenovirus), a preparation of Retroviridae (Lentivirus, Murine Leukemia virus), or a preparation of Herpesviridae (Herpes Simplex virus).

### III. Methods of Characterizing a Preparation of Biomolecules

In examples, methods of characterizing a preparation of biomolecules are provided. Exemplary biomolecules are described above. In some examples, the biomolecule is an antibody or fragment thereof, for example, a monoclonal antibody or fragment thereof. In other examples, the biomolecule is bacterial 70S ribosome (such as E. coli 70S ribosome) or a human 80S ribosome.

In some examples, methods of characterizing a preparation of biomolecules include subjecting a preparation of the biomolecules to analytical ultracentrifugation under sedimentation velocity conditions and measuring sedimentation of the biomolecules at a plurality of time points. The methods also include determining a frictional ratio function c(s,ff0) and a sedimentation coefficient for the preparation of viral particles, plotting the function c(s,ff0) versus the sedimentation coefficient(S) and the frictional ratio (ff0) to obtain a c(s,ff0) distribution, and characterizing the preparation of biomolecules based on the c(s,ff0) distribution. In other examples, the methods include determining frictional ratio (e.g., molecular shape), estimated molecular weight, and/or Stokes radius (e.g., diameter) of the biomolecules.

In other examples, the methods include plotting the function c(s,ff0) versus S and M (molecular weight), plotting the function c(s,ff0) versus S and Rs, plotting the function c(s,ff0) versus S and D (diffusion), and/or plotting the function c(s,ff0) versus ff0 and M. These plots support further understanding of sample composition in addition to component identification because they correlate sedimentation rate and frictional ratio with other specific variables like molecular weight, diffusion, and hydrodynamic radius.

### EXAMPLES

The following examples are provided to illustrate certain particular features and/or examples. These examples should not be construed to limit the disclosure to the particular features or examples described.

### Example 1

Analysis and Characterization of AAV Viral Particles Sample Preparation: Samples were thawed from −80° C. storage to room temperature and thoroughly mixed by pipetting up and down. The buffer matching the composition of the sample matrix was obtained to be used for sample dilution and for background correction. To prepare samples in the correct concentration range for SV-AUC UV detection, a UV spectrophotometer was used to determine the Optical Density at 280 nm (OD₂₈₀) of all samples. The OD₂₈₀ was measured three (3) times and an average was calculated. The dilution factor was determined based on the average OD₂₈₀ to get the optical density of the samples to fall between 0.4-0.6 OD₂₈₀. If the absorbance was lower than 0.4, the sample may be used neat. Using a Beckman-Coulter An-50 Ti analytical 8-place titanium rotor, seven (7) whole assembly SV-AUC cells were built using a centerpiece, two-sector 12-mm flow-through, and two quartz windows (the 8th position is reserved to the counterbalance). One sector was assigned to contain the sample and the other sector to the corresponding buffer: sample volumes must be 400 μL and buffer volumes is 410-420 μL. One cell was assigned the reference material (70S ribosome), and the six other cells contained the samples.

AUC Preparation: On a Beckman-Coulter Optima AUC instrument, the method scan was set with the following parameters: AN 50 Ti rotor, temperature 20° C.; set scans to Absorbance only in Module 1; method stages set to Stage 1 Equilibration: 0 RPM, delay 2 hours; Stage 2 Analysis: 15,000 RPM, delay 0 hours; Stage 3 Hold, 0 RPM, delay 0 hours. In Stage 2, select cells 1-7, enter 75 scans, 280 nm, scan frequency 20 seconds, data resolution 10 μm, Min. Radius (cm) 5.8, Max. Radius (cm) 7.2, one (1) replicate. A vacuum test was performed before running the samples.

Data Analysis by SEDFIT using c(s, ff0): Raw data was imported from the Optima AUC. The scans were loaded into SEDFIT, one cell at a time. c(s,ff0) was chosen under Model. The parameters under Parameters were set to: resolution: 100 S, s min. 2.00000, s max. 200, check fit RI and Time Independent Noise boxes. Buffer density and buffer viscosity were adjusted depending on the buffer used in the sample matrix. Vbar was kept at 0.73. On the scan profile, the red line was set to coincide with the sample meniscus and the left green line was set to coincide with the best lower range value for the analysis to begin. The regularization model was already set to Maximum Entropy since it is the default for the c(s,ff0) analysis. The confidence level (F-ratio) was set at 0.95. The default plot was set to s-ff0. After running SEDFIT, the RMSD value was recorded, peaks are integrated, and percentage composition was calculated from the peak areas.

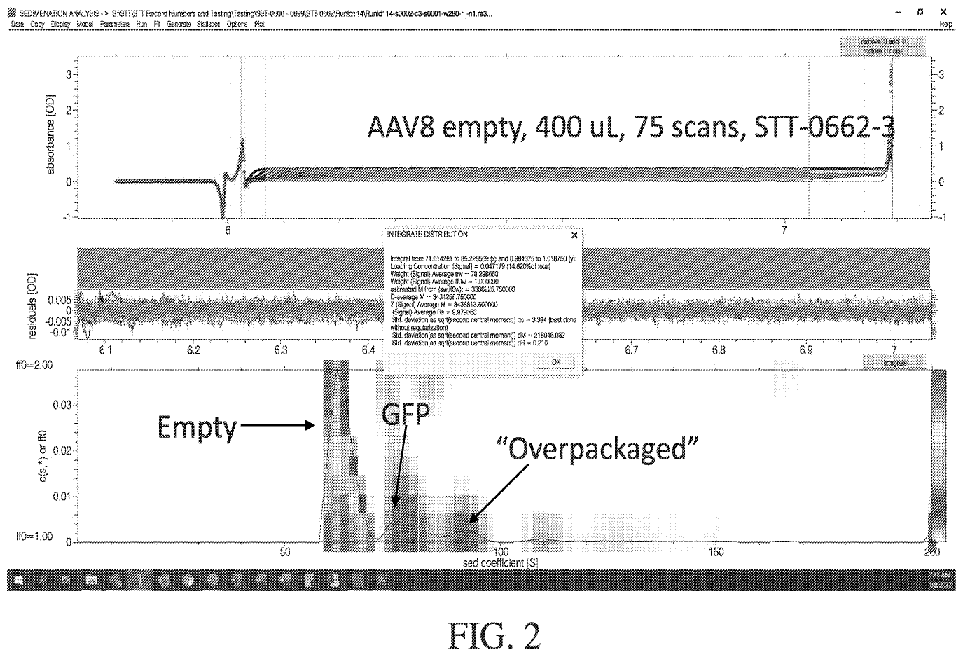

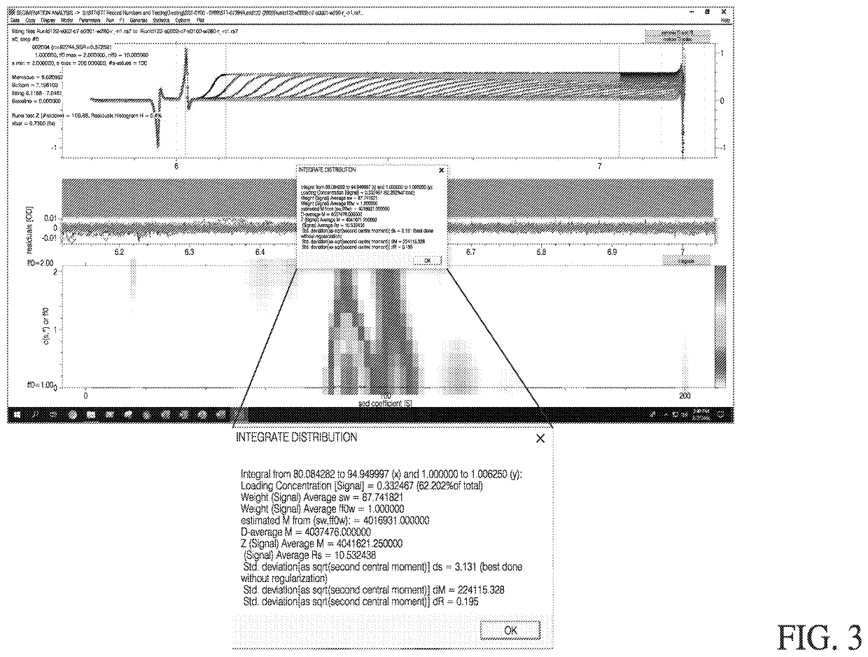

Results: A distribution profile using c(s,ff0) for an AAV8 preparation is shown in FIG. 2. As shown in the lower panel, peaks representing empty particles, GFP containing particles, and overpackaged particles (containing genome size greater than that for the GFP genome size) can be identified. FIG. 3 shows a distribution profile using c(s,ff0) that was utilized to calculate frictional ratio (f/f0), molecular weight (sw, ffow), and Stokes radius (Rs) of AAV2, AAV3, AAV6, AAV8, and AAV9 preparations. The results are shown in Tables 1-3. Based on the calculated results, all species were spherical, had molecular weights consistent with what was expected for their type, and had diameters around 20-25 nm, consistent with historical and published data.

TABLE 1
Frictional ratio (f/f0)

| Viral Vector | Type | n | AVG f/f0 | % CV |
|---|---|---|---|---|
| AAV2 | GFP | 2 | 1.000000 | 0 |
| AAV3 | Empty | 1 | 1.044685 | NA |
| AAV3 | GFP | 1 | 1.000000 | NA |
| AAV6 | Empty | 1 | 1.000000 | NA |
| AAV6 | GFP | 1 | 1.000000 | NA |
| AAV8 | Empty | 3 | 1.000000 | 0 |
| AAV8 | GFP | 3 | 1.000000 | 0 |
| AAV9 | Empty | 1 | 1.000000 | NA |
| AAV9 | GFP | 1 | 1.166479 | NA |

TABLE 2
Molecular weight (sw, ffow)

| Viral Vector | Type | n | AVG MW (MDa) | % CV |
|---|---|---|---|---|
| AAV2 | GFP | 1 | 4.06 | NA |
| AAV3 | Empty | 1 | 2.74 | NA |
| AAV3 | GFP | 1 | 4.10 | NA |
| AAV6 | Empty | 1 | 2.15 | NA |
| AAV6 | GFP | 1 | 3.97 | NA |
| AAV8 | Empty | 3 | 2.46 | 0 |
| AAV8 | GFP | 3 | 4.02 | 0 |
| AAV9 | Empty | 1 | 2.39 | NA |
| AAV9 | GFP | 1 | 5.16 | NA |

TABLE 3
Stokes radius (Rs)

| Viral | | | AVG Stokes Rs | % | Diameter |
|---|---|---|---|---|---|
| Vector | Type | n | (nm) | CV | (nm) |
| AAV2 | GFP | 1 | 10.8 | NA | 21.6 |
| AAV3 | Empty | 1 | 9.77 | NA | 19.5 |
| AAV3 | GFP | 1 | 10.7 | NA | 21.4 |
| AAV6 | Empty | 1 | 8.56 | NA | 17.1 |
| AAV6 | GFP | 1 | 10.5 | NA | 21.0 |
| AAV8 | Empty | 3 | 8.99 | 0 | 18.0 |
| AAV8 | GFP | 3 | 10.5 | 0 | 21.0 |
| AAV9 | Empty | 1 | 8.91 | NA | 17.8 |
| AAV9 | GFP | 1 | 13.5 | NA | 27.0 |

### Example 2

### Characterization of 70S Ribosome

Bacterial 70S ribosome was selected as a reference material for AUC. This molecule is a mixture of protein and nucleic acid and has a molecular weight of 2.5 MDa, which is similar to empty AAV (between 2.7-3.0 MDa). 70S has a spherical shape, 50S is also spherical, and 30S is more elongated, but is still considered spherical. Utilizing the AUC methods described in Example 1, 70S ribosome was characterized. Two prominent peaks corresponding to 30S and 50S subcomponents were observed, and one small peak for 70S. The 30S and 50S components consistently sedimented at the same rate (n=8). C (s,ff0) modeling results are provided in Table 4. Average RMSD was 0.0022 (% CV=33%). All runs met the RMSD acceptance criterion of ≤0.01.

TABLE 4
70S ribosome c(s, ff0) modeling

| Ribosome | | | Estimated |
|---|---|---|---|
| Com- | | | Molecular Weight |
| ponent | Peak Area | Sedimentation (S) | (MDa) |
| 30S | 0.190 (% CV = 9%) | 23.5% (% CV = 2%) | 0.540 (% CV = 1%) |
| 50S | 0.390 (% CV = 4%) | 40.2 (% CV = 0.8%) | 1.24 (% CV = 1%) |
| 70S (n = 2) | 0.007 (% | 64.7 (% CV = 9%) | 2.38 (% CV = 11%) |
| | CV = 17%) | | |

### Example 3

### Exemplary AUC Work Flow

The work flow provided is exemplary for analysis of AAV particles. One of ordinary skill in the art would understand that certain aspects of the work flow can be varied, for example, depending on the biomolecule to be analyzed.
1. Experimental Setup:
   a. Samples are run on a Beckman Coulter Optima analytical ultracentrifuge.
   b. One cell is assigned to a reference sample (e.g., 70S ribosome).
   c. Remaining cells are assigned to samples.
2. Ultracentrifugation is carried out with data collection set at 75 scans at 280 nm.
3. Import raw data files into an assay folder and all 75 scans for the cell to analyzed are selected.
4. Import all files into SEDFIT and select the c(s,ff0) function.
5. Set analysis parameters, for example:
6. Set sample meniscus lower range value for scanning.
7. Run calculations.
8. Record RMSD value.
9. Integrate peak areas and record sedimentation coefficients.
10. Calculate % composition using the peak areas.
11. Repeat steps 3-10 for each sample.

In view of the many possibilities to which the principles of the disclosure may be applied, it should be recognized that the illustrated examples should not be taken as limiting the scope of the invention. Rather, the scope of the invention is defined by the following claims. We therefore claim as our invention all that comes within the scope and spirit of these claims.

We claim:

1. A method of characterizing a preparation of viral particles, comprising:
subjecting the preparation of viral particles to analytical ultracentrifugation under sedimentation velocity conditions;
measuring sedimentation of the viral particles at a plurality of time points; determining a frictional ratio function c(s,ff0) and a sedimentation coefficient for the preparation of viral particles;
plotting the c(s,ff0) versus the sedimentation coefficient(S) to obtain a c(s,ff0) distribution; and
characterizing the presence and/or relative composition of viral particles comprising full viral genomes, partial viral genomes, overpackaged viral genomes, and/or empty viral particles in the preparation of viral particles.

2. A method of assessing genomic integrity of viral particles in a viral preparation, comprising:
subjecting the preparation of viral particles to analytical ultracentrifugation;
measuring sedimentation of the viral particles at a plurality of time points; determining a frictional ratio function c(s,ff0) and a sedimentation coefficient for the preparation of viral particles;
plotting the c(s,ff0) versus the sedimentation coefficient(S) to obtain a c(s,ff0) distribution; and
characterizing the presence and/or relative composition of viral particles comprising full viral genomes, partial viral genomes, overpackaged viral genomes, and/or empty viral particles in the preparation of viral particles, thereby assessing the genomic integrity of the viral particles in the viral preparation.

3. The method of claim 1, wherein measuring the sedimentation of the viral particles comprises measuring absorbance.

4. The method of claim 3, wherein the absorbance is measured at about 280 nm.

5. The method of claim 3, wherein measuring sedimentation of the viral particles at a plurality of time points comprises measuring the absorbance at about 75 time points.

6. The method of any one of claim 1, wherein time interval between each of the plurality of time points is 20 seconds.

7. The method of any one of claim 1, wherein the analytical ultracentrifugation is performed at about 15,000 rpm and/or at a temperature of about 20° C.

8. The method of any one of claim 1, wherein characterizing the presence of viral particles comprising full viral genomes, partial viral genomes, overpackaged viral genomes, and/or empty viral particles in the preparation of viral particles comprises identifying peaks in the c(s,ff0) distribution corresponding to a sedimentation coefficient corresponding to viral particles comprising full viral genomes, partial viral genomes, and/or empty viral particles.

9. The method of any one of claim 1, wherein the characterizing the relative composition of viral particles comprising full viral genomes, partial viral genomes, overpackaged viral genomes, and/or empty viral particles in the preparation of viral particles comprises integrating the area under each peak in the c(s,ff0) distribution.

10. The method of claim 9, wherein relative composition of each of viral particles comprising full viral genomes, partial viral genomes, overpackaged viral genomes, and/or empty viral particles in the preparation of viral particles is determined by comparing the peak area values within the preparation.

11. The method of any one of claim 1, wherein the c(s,ff0) is calculated using the Lamm equation.

12. The method of claim 10, wherein the Lamm equation is calculated using SEDFIT software package.

13. The method of any one of claim 1, wherein the viral particles are capsid particles.

14. The method of any one of claim 1, wherein the preparation of viral particles is a preparation of adeno-associated virus (AAV) particles or recombinant AAV particles.

15. The method of claim 14, wherein the AAV particles comprise one or more of AAV2 particles, AAV3 particles, AAV6 particles, AAV8 particles, and AAV9 particles.

16. A method of determining relative composition of adeno-associated virus (AAV) particles comprising full viral genomes, partial viral genomes, overpackaged viral genomes, and/or empty viral particles in a preparation of AAV particles, the method comprising:
subjecting the preparation of AAV particles to analytical ultracentrifugation at 15,000 rpm;
collecting absorbance data at 280 nm at 75 timepoints at 20 second intervals to measure sedimentation of the viral particles;
determining a frictional ratio function c(s,ff0) and a sedimentation coefficient for the preparation of viral particles;
plotting the c(s,ff0) versus the sedimentation coefficient(S) to obtain a c(s,ff0) distribution;
assigning peaks in the c(s,ff0) distribution to a category of viral particles selected from viral particles comprising full viral genomes, viral particles comprising partial viral genomes, overpackaged and empty viral particles;
integrating area under each peak in the c(s,ff0) distribution; and
comparing composition of AAV particles comprising full viral genomes, partial viral genomes, and/or empty viral particles in the preparation of AAV particles.

17. The method of claim 16, wherein the c(s,ff0) is calculated using the Lamm equation.

18. The method of claim 17, wherein the Lamm equation is calculated using SEDFIT software package.

19. The method of any one of claim 16, wherein the AAV particles are capsid particles.

20. The method of any one of claim 16, wherein the AAV particles comprise one or more of AAV2 particles, AAV3 particles, AAV6 particles, AAV8 particles, and AAV9 particles.
